(19) United States
(12) Patent Application Publication
(10) Pub. No.: US 2024/0327284 A1
(43) Pub. Date: Oct. 3, 2024

(54) ADMIXTURE FOR CEMENT

(71) Applicant: SIKA TECHNOLOGY AG, Baar (CH)

(72) Inventors: Liucheng ZHOU, Suzhou (CN); Hailang GAO, Suzhou (CN); Linyue YANG, Suzhou (CN); Yalei CHEN, Suzhou (CN)

(73) Assignee: SIKA TECHNOLOGY AG, Baar (CH)

(21) Appl. No.: 18/294,416

(22) PCT Filed: Sep. 8, 2022
(86) PCT No.: PCT/CN2022/117764

§ 371 Date: Feb. 1, 2024

(30) Foreign Application Priority Data
Sep. 13, 2021 (CN) 202111068878.5

(51) Int. Cl. C04B 24/26; C04B 7/13; C04B 7/32; C04B 7/52; C04B 28/00; C04B 28/04; C04B 28/06; C04B 103/00

(52) U.S. Cl. CPC C04B 24/2605; C04B 7/13; C04B 7/323; C04B 7/52; C04B 28/001; C04B 28/04; C04B 28/06; C04B 2103/006

(57) ABSTRACT

An admixture for cement, including: A) a comb polymer comprising the following partial structural units or consisting thereof: a) a mole fractions of a partial structural unit S1 of formula (I)

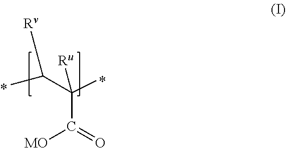

b) b mole fractions of a partial structural unit S2 of formula (II)

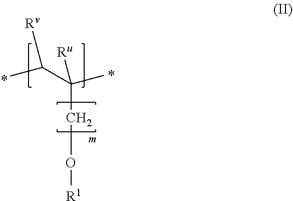

where M, R^{u}, R^{v}, m and R¹ are as defined in the invention; and B) optionally, alkanol amine.

The admixture for cement can provide remarkable improvement effects, particularly in milling aid effect, water-reducing properties, slump, fluidity and strength, for cements containing inferior or cheap mineral aggregate.

### TECHNICAL FIELD

The invention relates to an admixture for cement comprising a specific comb polymer, and particularly also to use of such an admixture for cement in cements such as sulphoaluminate cements and masonry cements.

### STATE OF THE ART

Cement is an inorganic, finely milled binder having a hydraulic function for mortars and concretes. When water is added, the cement paste formed is set by hydration to form a waterproof and volume-constant cementitious stone-like material.

According to the hydraulic material mainly contained therein, cement may be classified into, for example, silicate cement (or Portland cement), aluminate cement, sulphoaluminate cement, cement having pozzolan or latent hydraulic material and other active materials as main constituents, and the like.

Currently, in order to meet market demand, many cement plants wish to produce P.C 32.5 or P.C 32.5R grade cement as masonry cement (M32.5). For cost reasons, it is desired to produce masonry cement using cheap mineral aggregates (e.g. limestone, slag and fly ash) to replace a significant amount of clinker. Unfortunately, as the amount of these cheap mineral aggregates increases, the properties of the cement such as strength, water demand and workability are adversely affected.

Therefore, attempts have been made to improve the properties of these cements, particularly masonry cements, by adding admixtures, so as to compensate for the damage caused by inferior aggregates.

Admixtures for cement based on comb polymers, such as polycarboxylic acid types, are known in the prior art.

For example, US2009/0292041A1 discloses a strength improvement admixture composition capable of improving the compressive strength of cementitious compositions, the composition comprising polycarboxylate dispersant and strength enhancing additive. A series of useful polycarboxylate dispersants is proposed in the literature.

WO2015062798A1 also proposes an admixture composition for use in cementitious compositions to improve the properties thereof, the admixture composition comprising at least one polycarboxylate type comb polymer dispersant and a hydroxyl amine compound selected from EDIPA and optionally one or more polyhydroxyalkyl alkyleneamine compounds.

Furthermore, CN101065338A discloses aqueous compositions comprising polymer(s) useful as cement milling aids, the compositions comprising polymer A based on polycarboxylate type comb polymers.

However, the admixtures based on polycarboxylate type polymers proposed in these literatures are various. Also, although it is alleged that these admixtures have a significant effect of improving the properties of cement such as hardening behavior, fluidity and strength, the improvement effect of many polycarboxylate type polymers is not remarkable for some specific types of cements, for example, cements containing inferior or cheap mineral aggregate such as masonry cement and the like.

### SUMMARY OF THE INVENTION

Therefore, an object of the invention is to develop an admixture for cement which can provide effective performance improvement effects for general types of cements such as Portland cement, and in particular can also provide remarkable improvement effects on cements containing inferior or cheap mineral aggregate such as masonry cement and the like, particularly in regard to milling aid, water reduction, slump, fluidity and strength.

The inventors of the present application have now screened a very narrow range of polycarboxylate type polymers from the very broad polycarboxylate type comb polymers described in the prior art through a great deal of creative work, and have found that the admixture for cement comprising the very specific comb polymers as defined in claim 1 of the present application has excellent milling efficiency, and, as compared with other structurally similar polymers, is capable of extremely excellently improving the initial fluidity of a slurry, extremely remarkably reducing the slump loss of mortar or concrete and improving the strength. Such significant improvement effects make them particularly suitable for specialty cements such as sulphoaluminate cement, and more suitable for the cement products of poorer quality such as masonry cement, allowing these cements, which would otherwise be discarded or used at low-end due to a large amount of inferior aggregates contained therein, useful in a broader application range.

Other aspects of the invention are the subject matter of other independent claims. Particularly preferred embodiments of the invention are the subject matter of dependent claims.

### DETAILED DESCRIPTION OF THE INVENTION

The invention provides an admixture for cement, comprising:
A) a comb polymer comprising the following partial structural units or consisting thereof:
   a) a mole fractions of a partial structural unit S1 of formula (I)

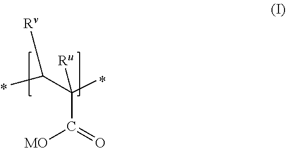

b) b mole fractions of a partial structural unit S2 of formula (II)

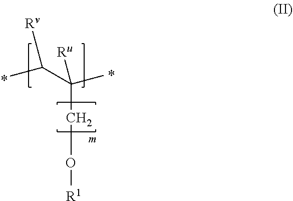

where M independently of one another represents H⁺, an alkali metal ion, alkaline earth metal ion, a bivalent or trivalent metal ion, an ammonium ion or an organic ammonium group, each R^{u} independently of one another stands for hydrogen or a methyl group, each R^{v} independently of one another stands for hydrogen or COOM,
m=0, 1 or 2,
R¹ independently of one another stands for —Y—R⁴,
   where
      Y stands for a divalent poly(alkyleneoxy) group containing a moiety of -[EO]ₙ—, in which E is a C₂-alkylene group and n=35 to 85, and
      R⁴ stands for H, a C₁ to C₂₀-alkyl group or -alkylaryl, or cyclohexyl group,
with the proviso that a/b is in a range of (2.6-3.8):1, preferably (2.7-3.7):1, more preferably (2.8-3.6):1; and
B) optionally, alkanol amine.

In a preferred embodiment, Y stands for a poly(alkyleneoxy) group consisting of (C₂- to C₄-alkylene-O—) units, for example, a poly(alkyleneoxy) group consisting of (C₂- and C₃-alkylene-O—) units, i.e., EO and PO units, wherein the molar ratio of all the C₂-alkylene-O-units (the EO-units) (or the moiety of -[EO]ₙ—) is at least 90%, especially preferably at least 95% or 100%, based on the total poly(alkyleneoxy) group. Particularly preferably, Y stands for a poly(alkyleneoxy) group consisting of a moiety of -[EO]ₙ—. If the total molar fraction of EO units is less than 90%, it may result in a decrease in water reduction and fluidity retention properties of concrete.

It is also preferred that the number of EO-units (i.e. n) is from 43 to 80, more preferably from 48 to 70, for example from 50 to 65 or from 50 to 60.

The inventors of the present application have found that in the structure of polycarboxylate type comb polymers, in particular in the partial structural unit S2 of formula (II), the poly(alkyleneoxy) side chains should be attached to the main chain via a spacer as short as possible, and that the specific number of EO-units and the specific ratio of a/b are very important for further improving the fluidity and strength of cement slurries, in particular for masonry cement and sulphoaluminate cement. More specifically, as shown in the examples, it has been found that a ratio of a/b within the specific range as claimed above can lead to better cement workability. The number of EO-units as defined herein can contribute to a better reduction in fluidity loss.

Specifically, on one hand, as shown in the examples, when a/b (i.e., the molar ratio of the partial structural unit S1 to the partial structural unit S2) is less than 2.6, the smaller the a/b value becomes, the poorer the water reducing function and fluidity improving effect of the comb polymer are. When a/b is higher than 3.8, the larger the a/b value becomes, the poorer the fluidity-retaining effect of the comb polymer is, leading to an increased fluidity loss.

On the other hand, as shown in the examples, according to the invention, only when n is within the range of 35 to 85, an admixture comprising the comb polymer of the invention can make a mortar concrete combine improved water-reducing property and slump-retaining property.

Therefore, when the value of a/b and the value of n are simultaneously kept within the narrow range required by the invention, it is possible to obtain optimum water-reducing property and slump-retaining property while maintaining or even improving the strength of a cement mortar.

In the invention, the alkyl or alkylaryl group preferably has from 1 to 16, more preferably from 1 to 12 carbon atoms. The alkylaryl group preferably has at least 6 or 7 carbon atoms. The alkyl group or the alkyl group contained in the alkylaryl group may be straight-chain or branched. Examples of such alkyl or alkylaryl groups include methyl, ethyl, propyl, butyl, pentyl, hexyl, heptyl, octyl, nonyl, decyl, undecyl, dodecyl, lauryl, tolyl, ethylphenyl, dimethylphenyl and the like. Preferably, the C₁-to C₂₀-alkyl or -alkylaryl group is selected from methyl, ethyl or propyl.

The order of the partial structural units S1 and S2 may be alternating, block or random, with block being preferred. In principle, it is also possible for further structural units to be present in addition to the partial structural units S1 and S2.

Preferably, the partial structural units S1 and S2 together have a weight fraction of at least 85% by weight, in particular at least 90% by weight, very particularly preferably at least 95% by weight, based on the total weight of the comb polymer. Particularly preferably, the comb polymer consists of the partial structural units S1 and S2.

Preferably, the weight average molecular weight (Mw) of the comb polymer is in particular 5,000-150,000 g/mol, especially 10,000-100,000 g/mol. In the invention, the molecular weight is determined by gel permeation chromatography using polystyrene as a standard.

According to one advantageous embodiment, the comb polymer is preferably substantially free of further aryl-containing partial structural units in the main chain and/or side chains, such as aromatic-substituted acrylates or arylalkyl acrylates and the like, except for the aryl groups which may be contained at the ends of the polyether (poly(alkyleneoxy)) segments of the partial structural unit II. The aryl group includes, for example, an aromatic group having 6 or more carbon atoms, such as 6 to 12 or 6 to 8 carbon atoms, such as phenyl group.

Furthermore, according to another advantageous embodiment, the comb polymer is preferably substantially free of further partial structural units having amide or amine side chains, for example, (meth)acrylic structural units having amide or amine side chains, such as (meth)acrylamide or aminoalkyl (meth)acrylate structural units.

Preferably, the polymer comprises these further structural units, in particular the partial structural units having amide or amine side chains, in an amount of not more than 5% by weight, preferably not more than 3% by weight, more preferably not more than 2% by weight, and most preferably is completely free of them, based on the total weight of the polymer.

It has been found that if the amount of these further structural units is too high, a decrease in the water-reducing rate may be caused. In particular, an increase in the amount of the partial structural units having amide or amine side chains may cause an increase in the air content of mortar or concrete, thereby affecting the strength of the mortar or concrete. In addition, polymers having a significant amount of these structural units are susceptible to milling by the milling body and to temperature in the mill during cement milling preparation process, thereby affecting the milling performance.

The partial structural units having amide or amine side chains may be generally represented by the following partial structural units S3 or S4:

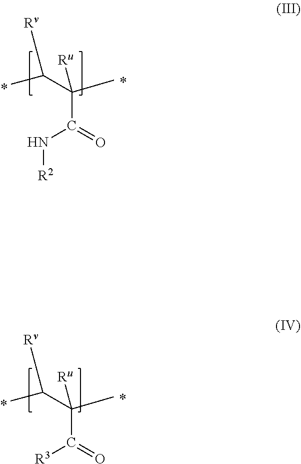

wherein
R^{u} and R^{v} each independently of one another have the definitions given in the partial structural units S1 and S2;
R² independently of one another represents C₁- to C₂₀-alkyl group, -cycloalkyl group, -alkylaryl group or polyether chain;
R³ independently of one another represents —NH₂, —NR⁵R⁶, —OR⁷NR⁸R⁹,
wherein R⁵ and R⁶ independently of one another represent C₁- to C₂₀-alkyl group, -cycloalkyl group, -alkylaryl group or -aryl group, or represent hydroxyalkyl group or acetoxyethyl-(CH₃—CO—O—CH₂—CH₂—) or hydroxy-isopropyl-(HO—CH(CH₃)—CH₂—) or acetoxyisopropyl-(CH₃—COO—CH(CH₃)—CH₂—);
or R⁵ and R⁶ together form a ring which includes the nitrogen, thereby forming a morpholine ring or imidazoline ring,
R⁷ is C₂-C₄-alkylene,
R⁸ and R⁹ each independently of one another represent C₁- to C₂₀-alkyl group, -cycloalkyl group, -alkylaryl group, -aryl group or -hydroxyalkyl group.

Some products of comb polymers are commercially available. The preparation of comb polymers is also known per se to those skilled in the art and can be carried out, for example, by free-radical polymerization of a monomer mixture comprising the corresponding monomers of the formulas (Iₘ) and (IIₘ), which results in comb polymers having the partial structural units S1 and S2. The groups R^{u}, R^{v}, R¹, M and m herein are as defined above.

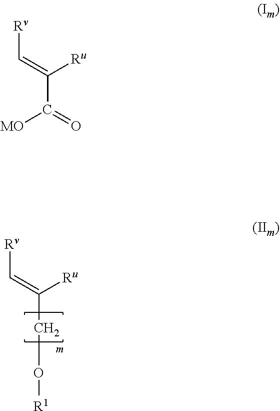

It is likewise possible to prepare comb polymers by polymer analogous reaction of a polycarboxylic acid of the formula (V), in which R^{v}, R^{u} and M are also as defined above.

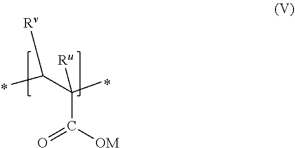

In polymer analogous reaction, the polycarboxylic acid of the formula (V) is esterified with the corresponding alcohol (e.g., HO—R¹), and then, if necessary, neutralized or partially neutralized (for example with metal hydroxides or ammonia, depending on the type of the group M). Details of polymer analogous reaction are disclosed, for example, on page 7, line 20 to page 8, line 50 of EP1138697B1 and examples thereof, or on page 4, line 54 to page 5, line 38 of EP1061089B1 and examples thereof. In one variant thereof, the comb polymers can be prepared in the state of a solid aggregate, as described on pages 3 to 5 of EP1348729A1 and examples thereof. The disclosures of said patent documents are specifically incorporated herein by reference. Preferably the comb polymers are prepared by polymer analogous reaction.

The comb polymers according to the invention can be used in the form of solids, dispersions or solutions, preferably as solutions, in particular aqueous solutions.

Very particularly suitable are comb polymers in which
a) the group R^{v} represents hydrogen,
b) the group R^{u} represents methyl group or a mixture of methyl group and hydrogen. In the latter case, the molar ratio of methyl group to hydrogen is in particular from 25:75 to 75:25, especially from 40:60 to 60:40.
c) m=0, and/or
d) R⁴ represents C₁-C₆ alkyl group such as methyl group or ethyl group.

In addition, in the admixture for cement according to the invention, the comb polymer is also optionally used in combination with an alkanolamine. The alkanolamine may be a di- or trialkanolamine, for example, selected from diethanol isopropanol amine (DEIPA), ethanol diisopropanol amine (EDIPA), triisopropanol amine (TIPA), triethanol amine (TEA), diethanol amine (DEA), methyldiethanol amine (MDEA), preferably one or more selected from DEIPA, EDIPA and TIPA.

Alkanolamine is important and beneficial for maintaining and further improving cement strength, including early strength and final strength, as well as improving production efficiency. The inventors have found that one or more alkanolamines selected from DEIPA, EDIPA and TIPA are preferred to other alkanolamines in terms of strength improvement effect, particularly when they are used in masonry and sulphoaluminate cements.

In an advantageous embodiment of the invention, the admixture comprises 0 to 50 wt. %, such as 10 to 40 wt. % or 15 to 35 wt. %, of the alkanolamine and 10 to 65 wt. %, such as 20 to 60 wt. % or 30 to 55 wt. %, of the comb polymer, based on the total weight of the admixture. The balance of the admixture may consist of water and optionally additional additives.

Those skilled in the art can adjust an appropriate ratio of the amounts of the alkanolamine and the comb polymer within the above range according to the desired effects.

In the admixture of the invention, although a low dosage of the admixture can be achieved, an amount exceeding 50% by weight of the alkanolamine is disadvantageous for the dispersion of the admixture in a mill and causes a waste of raw material. In general, the dosage of the alkanolamine may be in the range of 10 to 200 ppm, for example, 40 to 150 ppm, based on the weight of the cement.

In addition, an amount over 65% by weight of the comb polymer will make the viscosity of the admixture larger, which is disadvantageous for use while an amount of less than 10% by weight of the polymer will render the improving effect on the cement properties not significant. Correspondingly, the dosage of the comb polymer of the invention is preferably in the range of 150 to 1400 ppm, such as 200 to 1300 ppm or 500 to 1100 ppm, based on the weight of the cement. As shown in the examples, too little dosage of the polymer may cause an insignificant fluidity improvement, while over high dosage may cause a reduction in the strength of the cement mortar.

Further, preferably, the admixture for cement according to the invention may be added in a dosage of 0.01 to 0.50% by weight, preferably 0.03 to 0.35% by weight or 0.10 to 0.25% by weight, based on the weight of the cement. The admixture for cement may be used in form of an aqueous solution or dispersion.

In the case of the dosage of less than 0.01%, although the cement properties can be still improved to a limited extent, the dispersion of the admixture for cement in the mill is not facilitated and the mixing uniformity is affected due to the very small dosage. In the case of the dosage of more than 0.50%, although the dispersion of the admixture in the mill may be facilitated, such a high dosage may incorporate more moisture and excessive moisture may cause agglomeration of cement particles as well as ball pasting and mill pasting, affecting the subsequent delivery and transportation of the cement. In addition, excessive moisture incorporation may also result in a reduction of the cement strength.

The cement consists of a main constituent, possibly a small amount of calcium sulphate (gypsum and/or hemihydrate and/or anhydrite) and optionally a secondary constituent and/or cement additives (e.g. milling aids). The main constituent is used in an amount of more than 5 mass %. The main constituent may be silicate cement (Portland cement) clinker (also known as clinker), slag, natural or synthetic pozzolan, fly ash (e.g. silica or lime rich fly ash), fired shale, limestone and/or silica fume. As the secondary constituent, the cement may contain, for example, up to 5 mass % of finely milled inorganic minerals originating from clinker preparation or corresponding to other main constituents.

The cement suitable for use in the invention may be any common cement, for example five main classes of cements according to DIN EN 197-1: i.e., Portland cement (CEM I), Portland composite cement (CEM II), blast furnace cement (CEM III), pozzolana cement (CEM IV) and composite cement (CEM V). These main cement classes are in turn divided into 27 cement categories according to the dosage of their main constituents, said 27 cement categories being known to those skilled in the art and described in DIN EN 197-1. Of course, all cements produced according to other standards (for example the ASTM-standard or the Indian standard) are also applicable. If reference is made here to a cement category according to the DIN-standard, it is of course also relevant to corresponding cement compositions produced according to other cement standards.

Likewise, cements according to the GB175-2017 standard are also applicable, including: Portland cement, ordinary Portland cement, slag Portland cement, pozzolanic Portland cement, fly ash Portland cement and composite Portland cement. In addition, there are masonry cement specified in GB/T 3183-2017 and sulfoaluminate cement specified in GB20472-2006.

However, the inventors of the present application have found that, when the cement is particularly preferably masonry cement and sulphoaluminate cement, admixtures for cement comprising the specific comb polymers of the invention can surprisingly significantly improve the fluidity, milling efficiency and strength of such cements as compared to admixtures comprising other comb polymers.

Masonry cement is a hydraulic cementitious material prepared by adding a large amount of a low reactive or non-reactive mixed material such as blast furnace slag, fly ash and limestone powders to Portland cement clinker, and then mixing and milling with a proper amount of gypsum. Such a cement generally has a relatively low strength, and cannot be used for reinforced concrete or structural concrete, but is mainly used for masonry and plastering mortar, cushion concrete and the like of industrial and civil buildings. However, the inventors of the present application have found that the admixture for cement according to the invention is particularly effective for improving the strength, water demand and fluidity of cement comprising a relatively high amount of low reactive or non-reactive inferior or cheap mineral aggregates (e.g. limestone, slag, fly ash, coal slag, coal gangue, construction waste, sandstone, shale), thereby enabling more applications of these cement products which are generally regarded as low grades. Such cements typically comprise less than 70 wt %, such as less than 60 wt % or 55 wt %, of clinker, or comprise inferior mineral aggregates amounting to more than 30 wt % or 40 wt %, such as more than 45 wt % or 50 wt %. In a preferred embodiment, the admixture for cement of the invention is particularly effective for cements comprising up to more than 17 wt %, 20 wt %, or even 25 or 30 wt % or more of limestone, for example.

Sulphoaluminate cement is also a cement product generally known to the skilled person in the field of cement. Sulphoaluminate cement is a hydraulic cementitious material prepared by milling cement clinker containing anhydrous calcium sulphoaluminate and dicalcium silicate as main mineral constituents, which is obtained by calcining a green stock with proper composition, together with different amounts of limestone and a proper amount of gypsum. For example, calcium sulphoaluminate in the clinker of the sulphoaluminate cement can be resulted from the reaction of calcium oxide, aluminum oxide and calcium sulfate at a high temperature, such as 1000-1250° C.

In the preparation of cement, a milling usually needs to be carried out. Cement milling is used in particular for the formation of a reactive product from clinker and optionally other main constituents. For this purpose, clinker can be finely milled alone, optionally with the secondary constituent (usually up to 5 mass %) or with other main constituents. In order to regulate setting, gypsum is usually added to the milling material. During the co-milling or fine milling, the particle size distribution of individual constituents is not influenced. For optimal cement preparation, raw materials for cement can also be milled separately and then mixed, depending on different millability of the raw materials.

In the method of preparing cement according to the invention, at least one or preferably all of the main constituents of the cement are milled in the presence of the admixture for cement according to the invention, wherein the at least one of the main constituents preferably comprises clinker. In a particularly preferred embodiment, the cement mixture to be milled includes masonry cement and sulphoaluminate cement. The cement is present in the form of powder after milling.

The cement secondary constituent calcium sulfate or other cement additives may be added before or after milling, preferably they are added before milling. If not all cement main constituents are milled together in the presence of the admixture for cement according to the invention, the separately milled cement main constituents may be mixed thereafter. It is of course also possible to mill the separately milled cement main constituents in the presence of the admixture according to the invention.

The cement milling is usually carried out in a mill, of which preference is given to ball mills, material bed roller mills or vertical roller mills.

According to embodiments a cement composition of the present invention is characterized in that the cement is Portland cement and the cement composition additionally comprises limestone and at least one clay mineral, preferably a calcined clay, especially metakaolin. The “cement” in the cement composition of the present invention may thus be a mixture of Portland cement, limestone, and at least one clay mineral, preferably a calcined clay, especially metakaolin.

Throughout the present invention the term “clay mineral” refers to a solid material composed to at least 30 wt.-%, preferably to at least 35 wt.-%, especially to at least 75 wt.-%, each relative to its dry weight, of clay minerals. Such clay minerals preferably belong to the kaolin group (such as kaolinite, dickite, nacrite or halloysite), the smectite group (such as montmorillonite, nontronite or saponite), the vermiculite group, serpentine, palygorskite, sepiolite, chlorite, talc, pyrophyllite, micas (such as biotite muscovite, illite, glauconite, celadonite, and phengite) or mixtures thereof. Clay minerals belonging to the kaolin group, especially kaolinite, and micas, especially muscovite and illite, as well as mixtures thereof are especially preferred. A calcined clay is a clay material that has been put to a heat treatment, preferably at a temperature between 500-900° C., or in a flash calcination process at temperatures between 800-1100° C. A suitable flash calcination process is for example described in WO 2014/085538. According to embodiments, calcined clays are produced by heat treatment separately from other constituents of the binder composition and especially separately from the Portland cement and/or other pozzolanic and/or latent hydraulic materials present. According to especially preferred embodiments of the present invention, the calcined clay is metakaolin. Metakaolin is a material resulting from the calcination of kaolinite or minerals that are rich in kaolinite, e.g. have a content of kaolinite of at least 30 wt.-%, preferably to at least 35 wt.-%, relative to its dry weight. Calcination temperatures for the manufacturing of metakaolin typically are in the range of 500-900° C.

According to embodiments, the calcined clay is ground to a powder with a 45 μm residue as measured according to ASTM C 430-96 (2003) of at least 0.5 wt.-%, preferably at least 2 wt.-%, still more preferably at least 10 wt.-%, especially at least 20 wt.-%.

In preferred embodiments of the present invention the chemical compositions of limestone and Portland cement are as defined in standard EN 197-1:2011. In the alternative, limestone may also stand for magnesium carbonate, dolomite, and or mixtures of magnesium carbonate, dolomite, and/or calcium carbonate. It is especially preferred that limestone within the present context is a naturally occurring limestone mainly consisting of calcium carbonate (typically calcite and/or aragonite) but typically also containing some magnesium carbonate and/or dolomite. Limestone may also be a naturally occurring marl.

Limestone, within the present context, is a ground material that is not heat treated. Especially, the limestone is not decarbonated. According to embodiments, the limestone has a Blaine surface of 3′000-15′000 cm²/g.

The Blaine surface is measured as described in standard EN 196-6:2010.

According to embodiments, Portland cement is of the type CEM I, CEM II, CEM III, CEM IV or CEM V according to standard EN 197-1. Portland cements which are described in alternative standards, for example ASTM standards or Chinese standards are equally suitable. According to preferred embodiments, Portland cement is of type CEM I. According to embodiments, the Portland clinker content in a Portland cement of the present invention is at least 35 w %, preferably at least 65 wt.-%, especially at least 95 wt.-%, each based on the total dry weight of the cement. According to embodiments, the Portland cement clinker has an aluminium content, expressed as Al₂O₃, of less than 10 wt.-%, preferably less than 8 wt.-%, more preferably less than 6 wt.-%, in each case relative to the total dry weight of the clinker. According to especially preferred embodiments, the Blaine surface of the Portland cement as measured according to standard EN 196-6:2010 is between 1′500-10′000 cm²/g, preferably 2′000-9′000 cm²/g, especially 3′000-7′000 cm²/g. Preferably, the sulphate content of Portland cements of the present invention is optimized to an S03 content of not more than 4.0 wt.-%, relative to the total dry weight of the cement.

According to embodiments, a cement composition of the present invention comprises Portland cement and additionally limestone and at least one clay mineral, preferably a calcined clay, especially metakaolin, and a weight ratio of Portland cement to at least one clay mineral, preferably calcined clay, especially metakaolin, is from 33:1 to 1:1, preferably from 8:1 to 1:1.

According to embodiments, a cement composition of the present invention comprises Portland cement and additionally limestone and at least one clay mineral, preferably a calcined clay, especially metakaolin, and a weight ratio of Portland cement to limestone is from 20:1 to 1:4, preferably from 5:1 to 1:1.

According to embodiments, a cement composition of the present invention comprises Portland cement and additionally limestone and at least one clay mineral, preferably a calcined clay, especially metakaolin, and a weight ratio of at least one clay mineral, preferably calcined clay, especially metakaolin, to limestone is from 10:1 to 1:33, more preferably from 5:1 to 1:10.

According to embodiments, the “cement” in a cement composition of the present invention consists to at least 65 wt.-%, preferably at least 80 wt.-%, more preferably at least 92 wt.-%, in each case relative to the total dry weight of the cement, of calcined clay, limestone, and Portland cement.

According to embodiments of the present invention, a cement in a cement composition of the present invention comprises a mixture of
a) 25-100 mass parts of Portland cement,
b) 3-50 mass parts of at least one clay mineral, preferably calcined clay, especially of metakaolin,
c) 5-100 mass parts of limestone.

Especially, in such cement, the mass ratios of at least one clay mineral, preferably calcined clay, especially metakaolin, limestone, and Portland cement are as follows: Portland cement to at least one clay mineral, preferably calcined clay, especially metakaolin from 33:1 to 1:1, preferably from 8:1 to 1:1, at least one clay mineral, preferably calcined clay, especially metakaolin, to limestone from 10:1 to 1:50, preferably 10:1 to 1:33, more preferably from 5:1 to 1:10, and Portland cement to limestone from 20:1 to 1:4, preferably from 5:1 to 1:1.

According to a specific embodiment of the present invention, a cement in a cement composition of the present invention consists of a mixture of
a) 50 mass parts of Portland cement,
b) 20-50 mass parts of at least one clay mineral, preferably calcined clay, especially of metakaolin,
c) 10-50 mass parts of limestone.

According to embodiments, a cement composition of the present invention additionally comprises calcium sulfate in an amount of 1-8 wt.-%, relative to the total dry weight of the composition. A cement composition of the present invention does not comprise calcium sulfate as the main binder. Calcium sulfate can be in the form of gypsum, calcium sulfate dihydrate, calcium sulfate hemihydrate (in the alpha or beta form), and/or anhydrite.

According to embodiments of the present invention, a cement in a cement composition of the present invention consists to 92-99 wt.-%, relative to the total dry weight of the cement, of a mixture of
a) 25-100 mass parts of Portland cement,
b) 3-50 mass parts of at least one clay mineral, preferably calcined clay, especially of metakaolin,
c) 5-100 mass parts of limestone, and to 1-8 wt.-%, relative to the total dry weight of the cement, of calcium sulfate.

According to embodiments, a comb polymer of the present invention is used for reducing the fluidity loss of the cement, wherein the comb polymer is added into the cement in a dosage of 150 ppm to 1400 ppm before or during the milling, wherein the cement is a combination of Portland cement, limestone, and at least one clay mineral, preferably a calcined clay, especially metakaolin. The combination of Portland cement, limestone, and at least one clay mineral, preferably a calcined clay, especially metakaolin is as described above.

Suitable or preferred cements for use in the method according to the invention have been described above. In addition to the comb polymer and alkanolamine described above, additional additives, preferably aqueous additives, which may be added to the admixture for cement of the invention, may include other additives commonly used in the cement additive field and the concrete additive field. Examples include milling aids, surfactants, dispersing aids, wetting agents, thickeners, organic solvents, co-solvents, defoamers, carboxylic acids, preservatives, stabilizers, set control agents and acidity regulators. These additives may be added, for example, in an amount of 1 to 150 ppm based on the weight of the cement.

In a preferred embodiment of the invention, the admixture for cement further comprises a defoamer and/or a milling aid.

The air content in the cement mortar may increase with the addition of the polymer or the alkanolamine, which may be detrimental to the cement strength. So, a defoamer may be added as needed to reduce the air content. The defoamer may be added before, during or after milling. Suitable defoamers include phosphate compounds such as tributyl phosphate, polyethers, silicones, polyether modified polysiloxanes. Preferably, the dosage of the defoamer is 4 to 30 ppm based on the weight of the cement.

The milling aid may be selected from glycols, organic amines (alkanolamines as described above) and ammonium salts of carboxylic acids. Suitable glycols include (poly)alkylene glycols, such as glycols of the formula OH—(CH₂—CH₂—O)_{y}—CH₂CH₂—OH, wherein y is 0, 1, 2 or 3. The dosage of the milling aid may be 10 to 100 ppm based on the weight of the cement.

### EXAMPLES

The invention is further described below in connection with the examples. The invention, however, is not limited by these examples.

### 1. Main Raw Materials

TABLE 1

| Raw materials | Description |
|---|---|
| SikaGrind | Conventional milling aid product containing |
| | alkanolamine without comb polymer, commercially |
| | available from Sika |
| SikaGrind-800 | Formulated milling aid, comprising comb polymer, |
| | about 120 ppm of alkanolamine and 0-20 ppm of |
| | defoamer |
| Defoamer | Polyether defoamer |
| DEIPA | Diethanol isopropanol amine |
| EDIPA | Ethanol diisopropanol amine |
| TIPA | Triisopropanol amine |
| P.I | Laboratory milling cement |
| Reference | Reference cement for performance test of admixture |
| cement | for concrete in compliance with GB 8076 |
| Comb polymer | Self-made product |
| Admixed water | ViscoCrete product, commercially available from Sika |
| reducer | |

### 2. Preparation of Comb Polymer

A certain amount of deionized water and acrylic acid were added to a container with a stirrer, and mixed uniformly under stirring to prepare a material A. An oxidant was added to a container containing deionized water, and mixed uniformly under stirring to prepare a material B. A reducing agent was added to a container containing deionized water, and mixed uniformly under stirring to prepare a material C. While keeping the temperature at 20° C., the materials A, B and C were added dropwise to a reaction kettle containing polyether solutions with different a/b values, n values and EO ratios and a chain transfer agent to carry out reaction. By controlling the addition time, at the end of the addition, a mother liquor of comb polymer consisting of partial structural units S1 and S2 was prepared.

The main parameters of the obtained comb polymers were as follows:

| No. | a/b | n | EO/PO | No. | a/b | n | EO/PO |
|---|---|---|---|---|---|---|---|
| Polymer 8 | 1.44 | 54 | 100:0 | Polymer 40 | 6.0 | 54 | 100:0 |
| Polymer 6 | 2.0 | 54 | 100:0 | Polymer 7A | 3.5 | 48 | 90:10 |
| Polymer 5 | 2.4 | 54 | 100:0 | Polymer 7B | 3.5 | 42 | 80:20 |
| Polymer 4 | 2.9 | 54 | 100:0 | Polymer 7C | 3.5 | 36 | 70:30 |
| Polymer 7 | 3.55 | 54 | 100:0 | Polymer 8A | 3.6 | 21 | 100:0 |
| Polymer 36 | 4.0 | 54 | 100:0 | Polymer 9 | 3.8 | 90 | 100:0 |
| Polymer 38 | 4.55 | 54 | 100:0 | Polymer 4A | 3.8 | 112 | 100:0 |
| Polymer 39 | 5.0 | 54 | 100:0 | Polymer 4B | 7.0 | 90 | 100:0 |

### 3. Experimental Procedure

(1) Effects of Comb Polymers with Different a/b Values on Concrete Performance

A material with the cement ratio shown in Table 2 was weighed, and placed in a laboratory mill, and then blended with 800 ppm, based on the weight of the cement, of comb polymers with different a/b values. The milling time was controlled to ensure that the particle size distributions of the cements prepared by milling with different comb polymers were similar.

Next, by adjusting the dosage of an admixed water reducer, the initial slump of micro concrete was controlled to be 320±10 mm. After 30 min, the slump-retaining property of the micro concrete affected by the comb polymers with different a/b values was measured. In addition, the fluidity of mortar was measured with a water to cement ratio of 0.5 according to GB/T2419-2005.

TABLE 2
Cement formula

| Cement | Clinker | Gypsum |
|---|---|---|
| P.I | 95% | 5% |

TABLE 3
Effect of the comb polymers with different
a/b values on the concrete performance

| | | Slump of micro concrete | | | |
|---|---|---|---|---|---|
| Milling | | Dosage of | | | |
| aid or comb | | water reducer | 4 min/mm | 30 | Slump |
| polymer | a/b | (SC = 10%) | (320 ± 10 mm) | min/mm | loss/mm |
| SikaGrind | / | 1.15% | 323 | 168 | 155 |
| Polymer 8 | 1.44 | 0.93% | 323 | 223 | 100 |
| Polymer 6 | 2.0 | 0.78% | 320 | 250 | 70 |
| Polymer 5 | 2.4 | 0.65% | 330 | 240 | 90 |
| Polymer 4 | 2.9 | 0.60% | 325 | 260 | 65 |
| Polymer 7 | 3.55 | 0.60% | 318 | 240 | 78 |
| Polymer 36 | 4.0 | 0.60% | 320 | 220 | 100 |
| Polymer 38 | 4.55 | 0.60% | 320 | 220 | 100 |
| Polymer 39 | 5.0 | 0.60% | 328 | 218 | 110 |
| Polymer 40 | 6.0 | 0.60% | 325 | 205 | 120 |

As can be seen from the experimental results of Table 3, both good water reducing property and favorable slump-retaining property of the concrete can be obtained when the a/b value of the comb polymer is between 2.6 and 3.8.

(2) Effect of Comb Polymers with Different EQ Contents on Concrete Performance

The reference cement for performance test of concrete admixture in compliance with GB 8076 was used as test cement, and blended with 1600 ppm of comb polymers with different EQ/PG ratios, based on the weight of the cement. The initial slump and the slump after 20 m of the micro concrete were measured, and the results were shown in Table 4.

TABLE 4
Effect of the comb polymers with different
EO/PO ratios on the slump of the concrete

| | | | Slump of micro | |
|---|---|---|---|---|
| | EO/PO | Dosage of comb | concrete/mm | |
| No. | (a/b = 3.5) | polymer/ppm | Initial | 20 min |
| Polymer 7 | 100/0 | 1600 | 325 | 230 |
| Polymer 7A | 90/10 | 1600 | 190 | No slump |
| Polymer 7B | 80/20 | 1600 | 181 | No slump |
| Polymer 7C | 70/30 | 1600 | 162 | No slump |

As can be seen from Table 4, the initial slump of the concrete gradually decreases as the PQ content in the comb polymer increases, indicating that the water-reducing property of the comb polymer decreases as the EO content decreases. In addition, as can be seen from the retention results of the slump after 20 min of the concrete, the decrease in the EO content is also unfavorable for the slump-retaining property of the concrete.

### (3) Effect of n Value of the EO Unit on Concrete Performance

A material with the cement formula shown in Table 2 was weighed, and placed in a laboratory mill, and then blended with 800 ppm, based on the weight of the cement, of comb polymers with different n values. The milling time was controlled to ensure that the particle size distributions of the cements prepared by milling with different comb polymers were similar.

Next, by adjusting the dosage of an admixed water reducer, the initial slump of micro concrete was controlled to be 320±10 mm. After 30 min, the slump-retaining property of the micro concrete affected by the comb polymers with different n values was measured.

TABLE 5
Effect of different n values on the concrete performance

| | | Slump of micro concrete | | | |
|---|---|---|---|---|---|
| | | Dosage of | 4 min/mm | | |
| | | water reducer | (320 ± | 30 | Slump |
| Comb polymer | n | (SC = 10%) | 10 mm) | min/mm | loss/mm |
| Polymer 8A | 21 | 1.05% | 320 | 220 | 100 |
| Polymer 7 | 54 | 0.60% | 318 | 240 | 78 |
| Polymer 9 | 90 | 0.65% | 320 | 200 | 120 |
| Polymer 4A | 112 | 0.70% | 320 | 205 | 115 |

As can be seen from Table 5, when n<35 or n>85, the comb polymer caused a decrease in water-reducing property and/or slump-retaining property of the mortar concrete.

(4) Effect of Comb Polymers Combined with Different Alkanolamines on Concrete Performance

A material with the cement formula shown in Table 2 was weighed, and placed in a laboratory mill, and then blended with 400 ppm of the comb polymer Polymer 7 and 120 ppm of different alkanolamines, based on the weight of the cement. The milling time was controlled to ensure that the particle size distributions of the cements prepared by milling with different alkanolamines and the comb polymer were similar. The compressive strength of cement mortar was measured according to GB/T17671-1999, and the results were shown in Table 6.

TABLE 6
Compressive strength of the cement mortar

Compressive strength
of mortar/Mpa

| Admixture | Dosage/ppm | 3 d | 28 d |
|---|---|---|---|
| Polymer 7 | 400 | 27.5 | 50.2 |
| TEA+ Polymer 7 | 120 + 400 | 29.3 | 52.0 |
| DEIPA+ Polymer 7 | 120 + 400 | 29.7 | 55.2 |
| EDIPA+ Polymer 7 | 120 + 400 | 31.2 | 56.7 |
| TIPA+ Polymer 7 | 120 + 400 | 30.9 | 56.8 |

As can be seen from the above table, the alkanolamines are advantageous for improving the cement strength when used in combination with the specific comb polymer of the invention. However, the combination of the comb polymer of the invention with DEIPA, EDIPA, TIPA can improve the cement strength more significantly than the combination with TEA

### (5) Effect of Comb Polymer in Different Amounts on Cement Performance

In accordance with the different dosages shown in Table 7, the comb polymer Polymer 7 was added to a SikaGrind product containing alkanolamine to obtain a SikaGrind-800 product. According to the experimental dosages in terms of comb polymer based on the weight of the cement as shown in the table, the SikaGrind-800 product was blended into the cement mortar with the composition as shown in Table 2. A mortar was prepared and the strength of the mortar was measured according to GB/T 17671-1999, and moreover, the fluidity of the mortar was measured according to GB/T 2419-2005. The test results were shown in Table 7 below.

TABLE 7
Strength and fluidity of the mortar

| | Dosage in | Compressive strength of mortar/MPa | | | Mortar fluidity/ | |
|---|---|---|---|---|---|---|
| | terms of comb | Water/cement | | | Frequency of | |
| Admixture | polymer/ppm | ratio | 3 days | 28 days | jumping table | |
| Blank | 0 | 0.5 | 31.6 | 48.4 | 158/15 | s |
| 1# | 100 | 0.5 | 32.7 | 49.6 | 162/15 | s |
| 2# | 200 | 0.5 | 32.7 | 50.9 | 165/15 | s |
| 3# | 400 | 0.5 | 33.0 | 50.1 | 172/15 | s |
| 4# | 600 | 0.5 | 32.5 | 51.8 | 181/15 | s |
| 5# | 800 | 0.5 | 34.2 | 51.6 | 188/15 | s |
| 6# | 1200 | 0.5 | 37.5 | 51.1 | 230/15 | s |
| 7# | 1600 | 0.5 | 35.7 | 49.8 | 268/15 | s |
| 8# | 2000 | 0.5 | 34.1 | 48.9 | 265/4 | s |

As can be seen from the above table, an increase in the dosage of the comb polymer is helpful to increase the fluidity of the mortar, but an overhigh dosage of the comb polymer caused water bleeding or slurry bleeding and other phenomena on the surface of the mortar after molding, which may reduce the strength of the cement mortar (especially when the dosage is higher than 1600 ppm).

### (6) Effect of the Comb Polymer of the Invention on Sulphoaluminate Cement

A SikaGrind-800 product was prepared as described in (5). The SikaGrind-800 product was blended into sulphoaluminate cement mortar according to the experimental dosages as shown in the table. The experiment was carried out according to GB 20472. A mortar was prepared and the strength of the mortar was measured according to GB/T 17671-1999, and moreover, the fluidity of the mortar was measured according to GB/T 2419-2005. The test results were shown in Table 8.

TABLE 8
Effect on sulphoaluminate cement

| | | | | Compressive strength | |
|---|---|---|---|---|---|
| | | Fluidity of mortar | | of cement mortar/MPa | |
| Admixture | Dosage | W/C | /mm | 3 d | 28 d |
| Blank | | 0.47 | 165-175 | 33.6 | 43.1 |
| SikaGrind | 0.05% | 0.47 | 165-175 | 34.5 | 45.2 |
| SikaGrind-800 | 0.15% | 0.44 | 165-175 | 38.0 | 49.7 |

### (7) Effect of the Comb Polymer of the Invention on Masonry Cement

(i) Compared to conventional milling aid without the comb polymer: a SikaGrind-800 product was prepared as described in (5). The SikaGrind-800 product and conventional milling aid SikaGrind were respectively blended into masonry cement mortars with different compositions according to the experimental dosages as shown in the table. The test cement was obtained by mixing the constituents in the percentages shown in the table. The experiment was carried out according to GB 3183. A mortar was prepared and the strength of the mortar was measured according to GB/T 17671-1999, and moreover, the fluidity of the mortar was measured according to GB/T 2419-2005. The test results were shown in Tables 9 and 10

TABLE 9
Effect on masonry cement containing 20% limestone

| Admixture for cement | | Conventional milling aid | SikaGrind-800 |
|---|---|---|---|
| Cement formula | | 56% clinker, 6% gypsum, | 56% clinker, 6% gypsum, |
| | | 20% limestone, 10% slag | 20% limestone, 10% slag |
| | | and 8% fly ash | and 8% fly ash |
| Dosage | | 0.03% | 0.10% |
| Setting time, | Initial | 245 | 225 |
| min | Final | 361 | 343 |
| Fluidity of | Water/cement | 0.48 | 0.46 |
| mortar (25 s), | ratio | | |
| mm | Fluidity | 185 | 188 |
| Water retention | Water/cement | 0.48 | 0.46 |
| rate of mortar | ratio | | |
| | Water retention | 89.2% | 92.5% |
| | rate | | |
| Compressive | Water/cement | 0.48 | 0.46 |
| strength of | ratio | | |
| mortar, Mpa | 3 days | 19.2 | 34.8 |
| | 28 days | 20.8 | 35.3 |

TABLE 10
Effect on masonry cement containing 30% limestone

| Admixture for cement | | Conventional milling aid | SikaGrind-800 |
|---|---|---|---|
| Cement ratio | | 71% clinker, 4% gypsum, | 66% clinker, 4% gypsum, |
| | | 20% limestone and 5% slag | 30% limestone |
| Dosage | | 0.10% | 0.10% |
| Fluidity of mortar | Water/cement | 0.50 | 0.50 |
| (jumping table | ratio | | |
| controlled at | Fluidity under | 216 | 250 |
| 12 s), mm | the same water | | |
| | to cement ratio | | |
| Compressive | Water/cement | 0.50 | 0.50 |
| strength of | ratio | | |
| mortar, Mpa | 3 days | 28.6 | 26.6 |
| | 28 days | 50.2 | 51.1 |
| Concrete blind | Water/cement | 0.72 | 0.69 |
| test results | ratio | | |
| | Slump, mm | 200 | 195 |
| | Slump, mm | 370 | 400 |

* Without adding water reducer, the slump was controlled by adjusting the water to cement ratio.

As can be seen from Tables 9 and 10, SikaGrind-800 can significantly improve the fluidity of the cement mortar and concrete with a high dosage of limestone, and decrease the water demand of the cement mortar and concrete with a high dosage of limestone, which is beneficial for cement enterprises to use cement with a high dosage of inferior or cheap mineral aggregates.
(ii) Compared to non-inventive comb polymers:

A material with the cement formula shown in Table 11 below was weighed, and placed in a laboratory mill, and then blended with the comb polymers polymer 7 and polymer 4B respectively in a dosage of 800 ppm, based on the weight of the cement. The milling time was controlled to ensure that the particle size distributions of the cements prepared by milling with different comb polymers were similar. Next, by adjusting the dosage of an admixed water reducer, the initial slump of micro concrete was controlled to be 320±10 mm. After 30 min, the slump-retaining property of the micro concrete affected by the different comb polymers was measured.

TABLE 11
Effect of different comb polymers on masonry cement containing 45% limestone

| PCE | | polymer 7 | polymer 4B |
|---|---|---|---|
| Cement formula | | 50% clinker, 5% gypsum, | 50% clinker, 5% gypsum, |
| | | 45% limestone | 45% limestone |
| Dosage of SIKA ViscoCrete | | 1.30% | 1.30% |
| water reducer (SC = 10%) | | | |
| Slump of micro | 4 min/mm | 320 | 315 |
| concrete | (320 ± 10) | | |
| | 30 min | 170 | 123 |

As can be seen from the above table, for the cement with a lower clinker content, the slump-retaining property of the concrete after 30 min affected by the non-inventive comb polymer is inferior to that affected by the inventive comb polymer.

### (8) Effect of the Comb Polymer on Portland Cement Composition Comprising Metakaolin and Limestone

The initial slump flow was measured in a slump flow test according to EN 12350-8. The diameter of the cone used for slump flow measurements was 37.5 mm, thus a value of 37.5 mm in the below tables corresponds to a mix which has essentially no slump flow.

The following Table 12 gives an overview of chemicals used. All chemicals were used as supplied unless otherwise noted.

TABLE 12
chemicals used in these examples

| Name | Description |
|---|---|
| Metakaolin | Metastar 501 from Imerys Kaolin |
| Limestone | Nekafill 15 from Kalkfabrik Netstal AG |
| OPC | CEM I 42.5N |
| Gypsum | CaSO₄ (>99% purity) from Sigma-Aldrich |
| PCE-1 | Copolymer of acrylic acid and methyallyl alcohol |
| | started polyethylene glycol (Mn = 2,400 g/mol) to yield a |
| | molar ratio of carboxylic acid groups to side chains of 3.6 |
| PCE-2 | Copolymer of acrylic acid and methyallyl alcohol |
| | started polyethylene glycol (Mn = 2,400 g/mol) to yield a |
| | molar ratio of carboxylic acid groups to side chains of 2.2 |

The cement used in these examples was prepared by mixing 50 mass parts of OPC, 31.5 mass parts of metakaolin, 15 mass parts of limestone, and 3.5 mass parts of gypsum in dry state at 23° C./50% r.h. on a Heidolph propeller mixer for 2 min at 1′500 rpm. A visually homogeneous powder resulted.

The respective amounts of PCE, optionally alkanolamine, and water as indicated in below table 2 were then added to the cement powder. The resulting mixture was mixed on a Heidolph propeller mixer for 2 min at 1′500 rpm. The initial flow was measured directly after these 2 minutes mixing time.

In the following table 13, Ref-1 is a reference example not according to the invention. Compositions C-1 to C-7 are according to the invention.

TABLE 13
Composition of Ref-1, C-1 to C-7 (unless otherwise
indicated all numbers refer to weight in gram)

| | Ref-1 | C-1 | C-2 | C-3 | C-4 | C-5 | C-6 | C-7 |
|---|---|---|---|---|---|---|---|---|
| Binder | 100 | 100 | 100 | 100 | 100 | 100 | 100 | 100 |
| PCE-1 | | 0.142 | | 0.142 | 0.142 | 0.142 | 0.142 | 0.142 |
| PCE-2 | | | 0.194 | | | | | |
| TEA | | | | 0.05 | 0.1 | 0.5 | | |
| TIPA | | | | | | | 0.05 | 0.1 |
| water | 46 | 46 | 46 | 46 | 46 | 46 | 46 | 46 |
| Initial | 37.5 | 86 | 80 | 104 | 103 | 81 | 105 | 107 |
| slump [mm] | | | | | | | | |

It can be seen from the results presented in table 13 that an admixture of the present invention increases the initial slump of a cement composition comprising a cement based on Portland cement, metakaolin, and limestone.

1. Admixture for cement, comprising:
A) a comb polymer comprising the following partial structural units or consisting thereof:
a) a mole fractions of a partial structural unit S1 of formula (I) 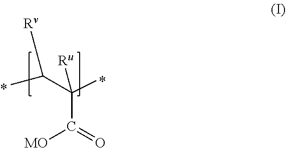
b) b mole fractions of a partial structural unit S2 of formula (II) 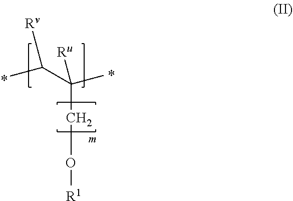
where M independently of one another represents H⁺, an alkali metal ion, alkaline earth metal ion, a bivalent or trivalent metal ion, an ammonium ion or an organic ammonium group,
each R^{u} independently of one another stands for hydrogen or a methyl group,
each R^{v} independently of one another stands for hydrogen or COOM,
m=0, 1 or 2,
R¹ independently of one another stands for —Y—R⁴,
where
Y stands for a divalent poly(alkyleneoxy) group containing a moiety of -[EO]ₙ—, in which E is a C₂-alkylene group and n=35 to 85, and
R⁴ stands for H, a C₁ to C₂₀-alkyl group or -alkylaryl, or cyclohexyl group,
with the proviso that a/b is in a range of (2.6-3.8): 1; and
B) optionally, alkanol amine.

2. Admixture according to claim 1, wherein the comb polymer comprise no more than 5 wt % of any other partial structural unit.

3. Admixture according to claim 1, wherein Y stands for a poly(alkyleneoxy) group consisting of (C₂- to C₄-alkylene-O—) units wherein the molar ratio of C₂-alkylene-O-units (EO) is at least 90% based on the total poly(alkyleneoxy) group.

4. Admixture according to claim 1, wherein Y stands for a poly(alkyleneoxy) group consisting of the moiety of -[EO]ₙ—.

5. Admixture according to claim 1, wherein the comb polymer is consisting of the partial structures S1 and S2.

6. Admixture according to claim 1, wherein the alkanol amine is selected from diethanol isopropanol amine (DEIPA), ethanol diisopropanol amine (EDIPA), triisopropanol amine (TIPA), triethanol amine (TEA), diethanol amine (DEA), methyldiethanol amine (MDEA).

7. Admixture according to claim 1, wherein the admixture contains 0-50 wt % of the alkanol amine and 10-65 wt % of the comb polymer, based on the total weight of the admixture.

8. Admixture according to claim 1, wherein the admixture contains further defoamers and/or diols.

9. Cement composition, characterized by comprising a cement and an admixture for cement as defined in claim 1.

10. Cement composition according to claim 9, wherein the cement is selected from sulphoaluminate cement and masonry cement.

11. Cement composition according to claim 9, wherein the cement is Portland cement and the cement composition additionally comprises limestone and at least one clay mineral.

12. Cement composition according to claim 11, wherein a weight ratio of Portland cement to at least one clay mineral is from 33:1 to 1:1.

13. Cement composition according to claim 11, wherein a weight ratio of Portland cement to limestone is from 20:1 to 1:4.

14. Cement composition according to claim 11, wherein a weight ratio of at least one clay mineral to limestone is from 10:1 to 1:33.

15. Cement composition according to claim 9, wherein the dosage of the admixture for cement is in a range of 0.01 to 0.50 wt %, based on the weight of the cement.

16. Cement composition according to claim 9, wherein the amount of the comb polymer is in a range of 150 ppm to 1400 ppm, based on the weight of the cement.

17. Cement composition according to claim 9, wherein the cement contains less than 70 wt % of clinker, based on the weight of the cement.

18. Cement composition according to claim 9, wherein the cement contains more than 17 wt % of limestone, based on the total weight of the cement.

19. A method for preparing a cement mixture, wherein the method comprises milling in presence of an admixture for cement as defined in claim 1 in a mill at least one main cement constituent or all of the main cement constituents.

20. Method according to claim 19, wherein the dosage of the admixture for cement is 0.01-0.50 wt % based on the weight of the cement.

21. A method for reducing the fluidity loss of a cement, comprising adding the comb polymer as defined in claim 1 into the cement in a dosage of 150 ppm to 1400 ppm, based on the weight of the cement, before or during milling.

22. Method according to claim 21, wherein the cement is selected from sulphoaluminate cement and masonry cement or is a combination of Portland cement, limestone, and at least one clay mineral.

23. Method according to claim 21, wherein the cement contains less than 70 wt % of clinker, based on the weight of the cement.

24. Method according to claim 21, wherein the cement contains more than 17 wt % of limestone, based on the weight of the cement.
